(19) United States
(12) Patent Application Publication
(10) Pub. No.: US 2009/0256955 A1
(43) Pub. Date: Oct. 15, 2009

(54) PORTABLE ELECTRONIC DEVICE WITH ROTATABLE IMAGE-CAPTURING MODULE

(76) Inventors: Hung-Sheng KUO, Taipei (TW); Yi-Chieh CHANG, Taipei (TW)

Correspondence Address: Muncy, Geissler, Olds & Lowe, PLLC, P.O. BOX 1364, FAIRFAX, VA, 22038-1364, US

(21) Appl. No.: 12/405,815

(22) Filed: Mar. 17, 2009

(30) Foreign Application Priority Data
Apr. 11, 2008 (TW) 097113179

(51) Int. Cl. H04N 5/225; H04M 1/00

(52) U.S. Cl. 348/376; 455/556.1; 348/E05.024

(57) ABSTRACT

A portable electric device with a rotatable image-capturing function includes a casing, a main circuit board and a touch pen. The main circuit board is disposed in the casing. The touch pen has a pen body and an image-capturing module disposed at one end of the pen body. The pen body is detachably coupled to casing. The image-capturing module and the main circuit board are electrically connected through the other end of the pen body.

### CROSS REFERENCE TO RELATED APPLICATIONS

This Non-provisional application claims priority under 35 U.S.C. §119(a) on Patent Application No(s). 097113179 filed in Taiwan, Republic of China on Apr. 11, 2008, the entire contents of which are hereby incorporated by reference.

### BACKGROUND OF THE INVENTION

1. Field of Invention

The present invention is related to a portable electronic device and, in particular, to a portable electronic device with an image-capturing function.

2. Related Art

In order to increase the utility of the portable electronic device, it not only has the basic communication or media playing function but also is equipped with the mechanism of specific function. For example, as shown in FIG. 1, a mobile phone 1 includes a casing 12, a touch-controlled screen 13, a main circuit board 14 and a key module 15. The touch-controlled screen 13 and the key module 15 are disposed in the openings of the casing 12 and are exposed from the casing 12. The main circuit board 14 is disposed inside the casing 12. To increase the operation precision and convenience of the touch-controlled screen 13, the mobile phone 1 may further include a touch pen 16. Thus, the user can use the touch pen 16 to precisely click the item displayed on the touch-controlled screen 13. Besides, the mobile phone 1 may include a camera module 18, so that the user can take a picture or a video any time any place. In general, the camera module 18 is usually disposed at one side of the mobile phone 1 and can not be rotated. Accordingly, when the user wants to shoot a picture of a target in different angles, he or she must rotate the mobile phone 1 to change the angle of the camera module 18. This will decrease the operation convenience for the user.

However, in the mobile phone 1 as shown in FIG. 1, the touch-controlled screen 13, key module 15, touch pen 16 and camera module 18 are independent components. Regarding to the main circuit board 14, the separate electronic elements are needed for communicating these components and controlling them with a processor (not shown). Thus, the density of the circuit layout on the main circuit board 14 will be very high, which may easily cause the electrical interference of neighbor electronic elements and increase the design difficulty of the circuit layout.

As shown in FIG. 2, another mobile phone 2 includes a display unit 21 and a host unit 22. The display unit 21 and the host unit 22 include a casing 211 and a casing 221, respectively, and are connected by a hinge 23. Thus, a camera module 212 disposed on the display unit 21 can be rotated with respective to the casing 221. Although the camera module 212 of the mobile phone 2 can be rotated through the hinge 23, some problems may occur if the display unit 21 is frequently rotated. For example, the circuit wires (not shown) between the display unit 21 and the host unit 22 may be deformed or broken.

### SUMMARY OF THE INVENTION

In view of the foregoing, the present invention provides a portable electronic device with a rotatable image-capturing module.

The present invention discloses a portable electronic device including a casing, a main circuit board and a touch pen. The main circuit board is disposed in the casing. The touch pen has a pen body and an image-capturing module disposed at one end of the pen body. The pen body is detachably coupled to casing. The image-capturing module and the main circuit board are electrically connected through the other end of the pen body.

As mentioned above, the portable electronic device of the present invention integrates the conventional image-capturing module and touch pen, so that the image-capturing module disposed at one end of the touch pen can be easily rotated over 270 degrees. In addition, the electrical connection between the image-capturing module and main circuit board is carried out through the touch pen, so the circuit layout on the main circuit board of the prior art for connection can be avoided.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic illustration of a conventional mobile phone;

FIG. 2 is a schematic illustration of another conventional mobile phone;

FIG. 3 is a schematic illustration showing a portable electronic device with a rotatable image-capturing module according to a preferred embodiment of the present invention;

FIGS. 4A, 4B and 4C are schematic views of the portable electronic device of FIG. 3, which is performing the image capturing function, wherein the image-capturing module is rotated to different angles; and

FIG. 4D shows another schematic view of the portable electronic device of FIG. 4C.

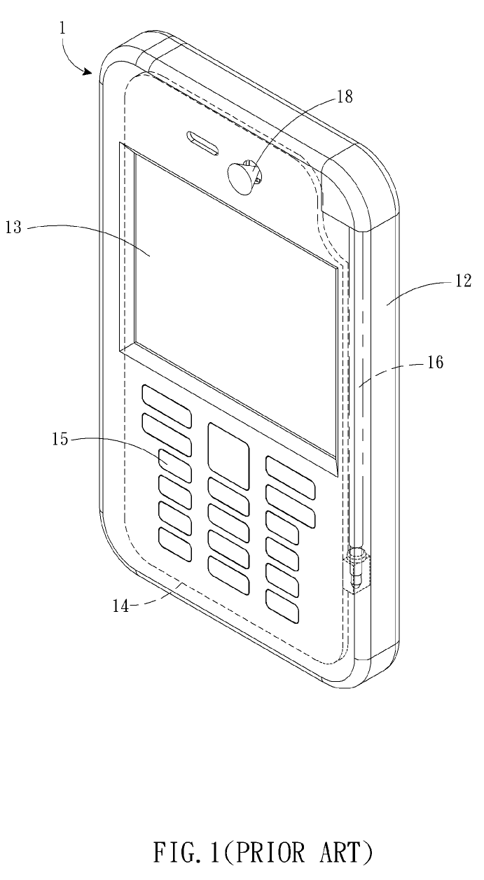

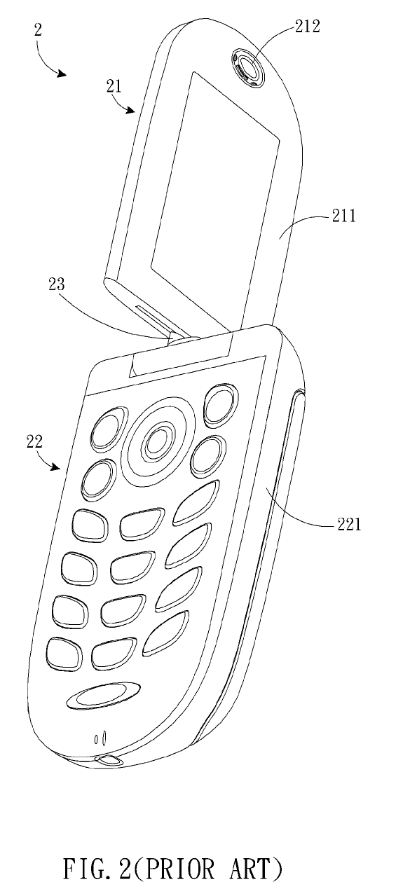

### DETAILED DESCRIPTION OF THE INVENTION

The present invention will be apparent from the following detailed description, which proceeds with reference to the accompanying drawings, wherein the same references relate to the same elements.

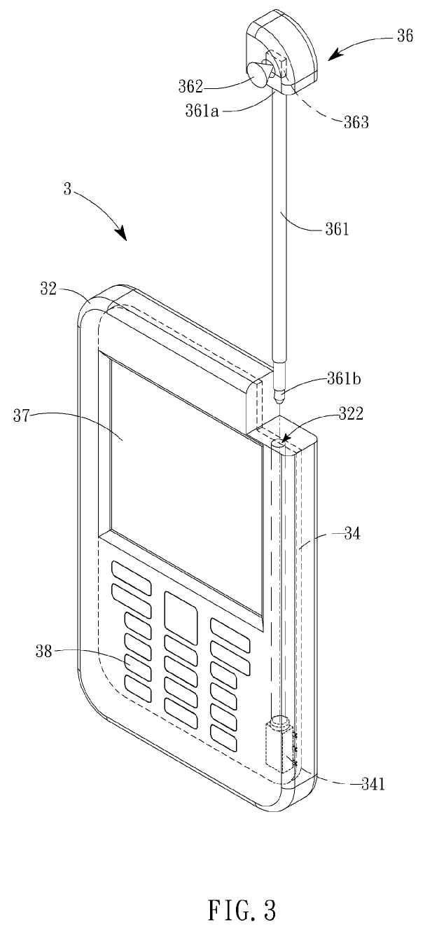

FIG. 3 is a schematic illustration showing a portable electronic device 3 with a rotatable image-capturing module according to a preferred embodiment of the present invention. As shown in FIG. 3, the portable electronic device 3 includes a casing 32, a main circuit board 34 and a touch pen 36. The portable electronic device 3 of the present invention is, for example, a computer, a mobile phone (such as a smart phone), a PDA, an MP3 player or an electronic book. In this embodiment, the portable electronic device 3 is a mobile phone.

The casing 32 is composed of two sub-casings, which are made of metal, alloy, plastic-steel, polymer, or their combinations. In the embodiment, the portable electronic device 3 may further include a touch panel 37 and a key module 38, which are exposed from the casing 32. The casing 32 includes an accommodating space 322, which fits to the touch pen 36, so that the touch pen 36 can be disposed in the accommodating space 322.

The casing 32 disclosed in this embodiment, which has the accommodating space 322 that can completely accommodate the touch pen 36, is for illustration only, and the aspects of the touch pen 36 accommodated in the casing 32 can be various depending on the different mechanical designs. The touch pen 36 can be partially disposed in the accommodating space 322 of the casing 32, or the accommodating space 322 can be a recess on the casing 32. In addition, the connection method between the casing 32 and the touch pen 36 is not limited to this aspect, which is carried out through the accommodating space 322. The casing 32 and the touch pen 36 can be connected with each other through a fixing element, or they can be connected and fixed according to the attraction of magnetic forces

The main circuit board 34 is disposed in the casing 32 and includes a connector 341 disposed adjacent to the accommodating space 322. When the touch pen 36 is disposed in the accommodating space 322, one end of the touch pen 36 is inserted into the connector 341, so that the touch pen 36 can be electrically connected to the main circuit board 34 through the connector 341.

The touch pen 36 includes a pen body 361 and an image-capturing module 362, which is disposed at one end 361a of the pen body 361 and is exposed from the casing 32. As shown in FIG. 3, the other end 361b of the pen body 361 is a plug for connecting with the connector 341, such as a socket. Since the pen body 361 includes a conductive material, the two ends 361a and 361b of the pen body 361 can electrically connected. In this casing, the pen body 361 can be totally composed of the conductive material or have a conductive material, such as a metal wire, disposed on its inner or outer surface. According to the conductive material, the image-capturing module 362 disposed at the end 361a of the pen body 361 can be electrically connected to the other end 361b of the pen body 361.

When the touch pen 36 is completely disposed in the accommodating space 322 of the casing 32, the end 361b of the touch pen 36 is inserted into the connector 341 of the main circuit board 34. Then, the image-capturing module 362 can be electrically connected to the main circuit board 34 through the end 361b of the touch pen 36 so as to provide the image-capturing function. When the touch pen 36 is pulled away to make the end 361b of the touch pen 36 detach from the connector 341, the image-capturing module 362 disposed at the end 361a of the touch pen 36 is disconnected to the main circuit board 34. In other words, the image-capturing module 362 is not electrically connected with the main circuit board 34. In this casing, the touch pen 36 can be simply used to operate the touch panel 37.

Referring to FIG. 3, in the embodiment, the image-capturing module 362 further includes a secondary circuit board 363, which is electrically connected to the conductive material of the touch pen 36. Then, the image-capturing module 362 can be electrically connected to the conductive material through the secondary circuit board 363, and further electrically connected to the main circuit board 34. The secondary circuit board 363 and the conductive material of the touch pen 36 can be electrically connected through a flexible circuit board or a connector (not shown), so as to electrically connect the image-capturing module 362 and the pen body 361 of the touch pen 36. Alternatively, since the pen body 361 is made of conductive material, the image-capturing module 362 can be directly welded to the end 361a of the pen body 361.

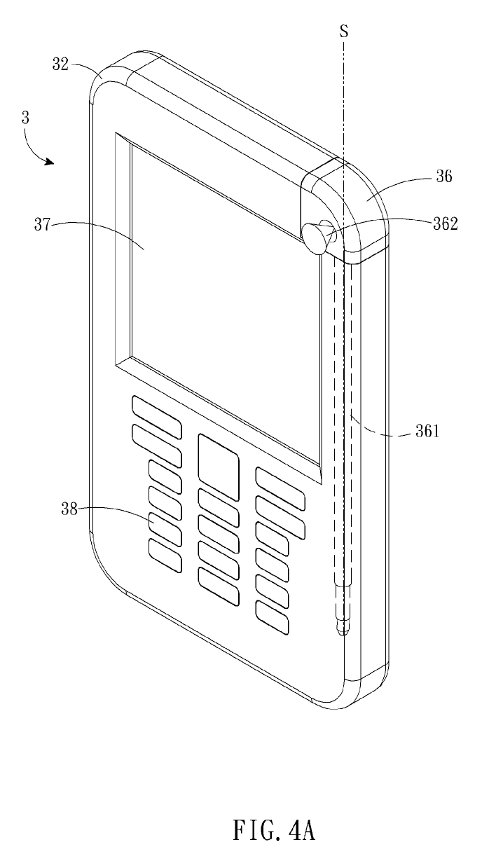

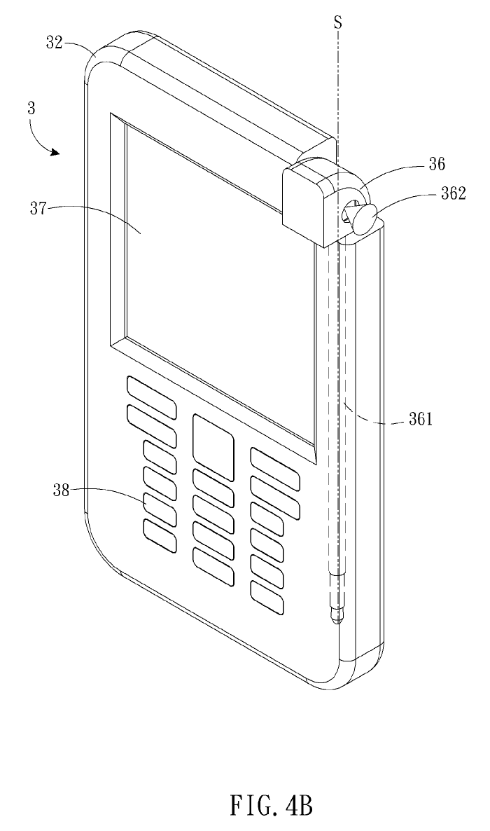

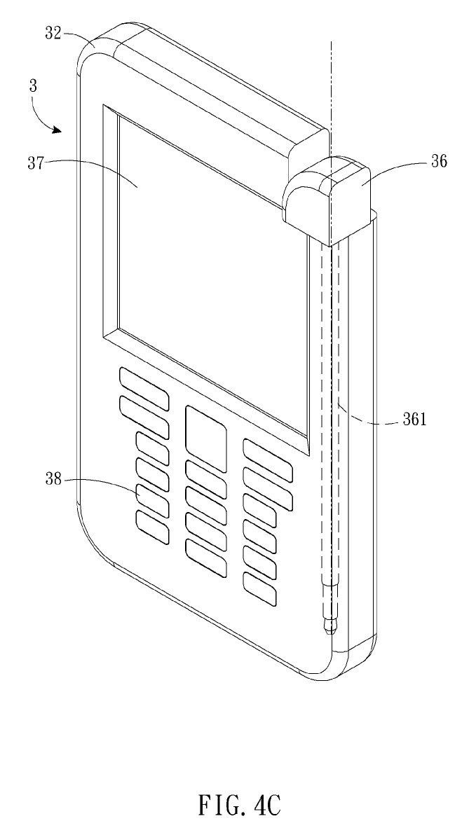

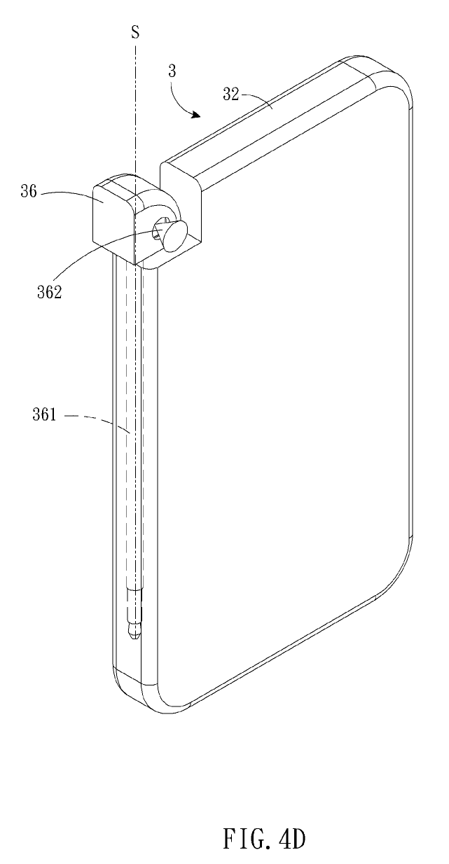

FIGS. 4A, 4B and 4C are schematic views of the portable electronic device 3, which is performing the image capturing function. When the user rotates the touch pen 36, the image-capturing module 362 is rotated to different angles.

As shown in FIG. 4A, the target shot by the image-capturing module 362 of the touch pen 36 is located at the same side as the touch panel 37 (or the key module 38).

Regarding to the casing 32, when the touch pen 36 is rotated by 90 degrees along the rotation axis S (the long axis of the pen body 361), the shooting direction of the image-capturing module 362 of the touch pen 36 and the display direction of the touch panel 37 have an included angle of 90 degrees (as shown in FIG. 4B). That is, the image-capturing module 362 can retrieve the target located aside the touch panel 37.

Referring to FIGS. 4C and 4D, regarding to the casing 32, when the touch pen 36 is rotated by 180 degrees along the rotation axis S, the shooting direction of the image-capturing module 362 of the touch pen 36 is opposite to the display direction of the touch panel 37. In other words, the image-capturing module 362 can retrieve the target located in back of the touch panel 37. Herein, FIG. 4D is a back view of the portable electronic device 3 of FIG. 4C.

To sum up, the portable electronic device of the present invention integrates the image-capturing function in the touch pen, so that the image-capturing module can shoot the target over 270 degrees. In addition, since the image-capturing module and the main circuit board are electrically connected through the pen body of the touch pen, the circuit layout on the main circuit board can be decreased so as to efficiently decrease the complexity and density of the circuit layout on the main circuit board.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A portable electronic device, comprising:
a casing;
a main circuit board disposed in the casing; and
a touch pen having a pen body and an image-capturing module disposed at one end of the pen body, wherein the pen body is detachably coupled to casing, and the image-capturing module and the main circuit board are electrically connected through the other end of the pen body.

2. The portable electronic device according to claim 1, wherein the casing has an accommodating space, and a part of the touch pen is disposed in the accommodating space.

3. The portable electronic device according to claim 1, wherein the main circuit board has a connector to connect with the pen body of the touch pen.

4. The portable electronic device according to claim 1, wherein the pen body of the touch pen comprises a conductive material for electrically connecting the image-capturing module to the main circuit board.

5. The portable electronic device according to claim 4, wherein the conductive material is disposed on an inner surface or an outer surface of the pen body.

6. The portable electronic device according to claim 4, wherein the image-capturing module comprises a secondary circuit board electrically connected with the conductive material.

7. The portable electronic device according to claim 6, wherein the secondary circuit board is electrically connected with the pen body by welding or through a connector or a flexible circuit board.

8. The portable electronic device according to claim 1, wherein the pen body of the touch pen is composed of a conductive material for electrically connecting the image-capturing module to the main circuit board.

9. The portable electronic device according to claim 1, wherein the touch pen comprises a rotational axis, and the touch pen is capable of rotating with respective to the casing along the rotational axis.

10. The portable electronic device according to claim 1, wherein the image-capturing module is exposed from the casing.
